(19) United States
(12) Patent Application Publication
(10) Pub. No.: US 2012/0199583 A1
(43) Pub. Date: Aug. 9, 2012

(54) Beverage utensil to create and enlarge vents/holes in disposable cup lids

(76) Inventor: Gregory Michael Kula, Parma, OH (US)

(21) Appl. No.: 13/385,145

(22) Filed: Feb. 2, 2012

Related U.S. Application Data
(60) Provisional application No. 61/462,390, filed on Feb. 2, 2011.

(51) Int. Cl. B65D 51/24; B26F 1/32

(52) U.S. Cl. 220/212.5; 30/358

(57) ABSTRACT

A device to add or enlarge vents to disposable drinking cup lids. The vents are created by a portion on one of the utensils' ends. The portion has one or more markings to describe the diameter of the vent that will be made when the portion is passed through a disposable cup lid. The vents that are produced from using the device allow the cup's beverage flow rate to be increased and the beverage to be consumed more quickly and quietly.

This application claims the benefit of provisional patent application 61/462,390 filed 2011 Feb. 2 by the present inventor.

### FIELD OF THE INVENTION

The present invention relates to utensils for table use and cooking use. More particularly, the invention relates to a utensil that can add or enlarge vents/holes to a disposable drinking cup lid. The modified lid allows more air surrounding the cup to enter the cup's interior, which minimizes or eliminates a potential vacuum created by the consumed beverage. When the vacuum is minimized or eliminated beverage consumption is easier and quieter. Consumer safety and beverage enjoyment are also increased when the lid is modified as close to beverage consumption as possible, because lid manufacturers can make as small a lid vent/hole as possible which helps insulate the beverage and decreases splashes and/or spills from cups having lids with open sip holes.

### BACKGROUND

U.S. Pat. No. 7,959,029 points out several observations about today's marketplace that serve hot and cold beverages in disposable cups with disposable lids. One goal of U.S. Pat. No. 7,959,029 is to allow consumers to purchase a beverage in a device or vessel that will enable the safe consumption of hot beverages, both during transit and/or stationary scenarios, while virtually eliminating splashing of fluid resulting from typical and conventional usage so as to avoid even a small splash of a hot beverage that could cause a serious accident, a burn to the consumer, a stain to the consumer's clothing, or another type of stain.

These unfortunate outcomes are serious. U.S. Pat. No. 7,959,029 mentions that a significant amount of litigation, with judgment awards ranging into the millions of dollars for legal fees and settlements, has resulted from personal burn injuries caused by hot beverage spillage. Moreover, liability insurance costs for food and beverage vendors, as well as across the board increases in insurance premiums, have become a consequential reality.

To prevent these undesirable outcomes the design of U.S. Pat. No. 7,959,029 attempts to delay egress of the flow through a sip hole long enough to enable the consumer to reflexively respond fast enough to capture and/or catch the cup and correct its orientation with little or no spillage in the event that a spill happens.

U.S. Pat. No. 7,959,029 also notes that in spite of the splash and spill issues related to hot beverages, consumers desire hotter beverages rather than less warm service temperatures. Vendors are pressured to provide consumers with very hot beverages, risking further exposure to splash and spill and burn incidents.

The desire to prevent heat loss is a reason why U.S. Pat. No. 7,959,029 says that many to-go containers attempt to address the insulation loss by using two cups, one nested down inside the other and still others use an extra insulation method by employing various external sleeves on the outside of the cup. Both of these methods and variations of them may improve relative heat loss of the beverage through the cup, but do not address any heat loss through the lid.

Heat loss through lids can take place through the cup's sip hole and vents/holes in the lid. The vents/holes prevent a vacuum from forming in the cup by allowing surrounding air to replace the consumed beverage. If a bigger sip hole were used the vents/holes could be eliminated. The lid's vents/holes could also be eliminated without increasing the sip hole size if the beverage consumer periodically stopped drinking long enough to allow surrounding air to enter though the sip hole and remove the vacuum that resulted when the beverage was consumed. Neither of these two solutions is favorable. An increase in the sip hole's size would increase the chances of heat and beverage loss from the cup through the bigger sip hole, and periodically drinking intermissions would be time consuming and require the beverage consumer to divide their attention between their life activities and preventing beverage stopping vacuums within the cup.

Some consumers may know that enlarging the vent would solve their problem. They may even have access to a pen, pencil, paperclip, pin, or toothpick that they could use to enlarge the vent.

One drawback to using pens, pencils, paperclips, and pins to make or enlarge vents/holes in disposable lids is that food preparation is not these items intended use. Because of their intended use they may not be clean enough to use for food preparation. A second concern with using available everyday items is lack of guidance. Consumers know that once the lid is punctured the enlarged hole cannot be repaired. The resulting sized vent may be too big and not provide the desired flow rate. So they are faced with trying to decide how far to insert these everyday items before they make too big a vent/hole. This lack of certainty might deter someone from trying to enlarge the lid's vent to solve their problem and endure the irregular flow rate and slurping sounds of current disposable lids.

A third problem with using everyday available items to create or enlarge vents/holes in lids is consistency. For example, if a satisfactory hole were made by a toothpick from a restaurant toothpick dispenser by inserting the toothpick's widest point through the lid, the user would not necessarily know that another toothpick from a different restaurant would produce the same result. Everyday items like toothpicks, pens, pencils, paperclips, and pins made by a manufacturer may for a variety of reasons not have the same dimensions as another toothpick, pen, pencil, paperclip, or pin made by the same or a different manufacturer. Two toothpicks may have the same color and look like they have the same diameter until they are compared side by side. Most beverage consumers do not know the manufacturing details of the disposable items they use, so there would be uncertainty that an everyday item like a toothpick could produce the same desired results as a previous item.

Identifying a utensil's dimensions that will be used to create or enlarge the desired holes in a disposable cup lid would certainly help increase user confidence that the selected tool would create the desired gauged vent/hole. U.S. Pat. No. 4,867,158 described how marking the length of an awl used in orthopedic surgery known would allow a surgeon and patient to be more confident that the selected tool would deliver the desired result. The invention allowed a surgeon to precisely select a predetermined bit length so that the first end of the awl's casing would contact the bone being drilled just as the hole was completed preventing further incursion of the bit into tissue behind the bone.

Unlike orthopedic surgeons, beverage thinkers are not interested in the depth of the hole they produce in their lid. They are interested in the diameter of the vent/hole, but like orthopedic surgeons they can be more confident in their tool selection if their utensil's dimensions are known when they are trying to make a vent not too small and not too big.

Ideally enlarging the lid's modified vent would start with a clean tool with a larger diameter than the original vent and after making a modified vent with the tool the consumer would be able to quickly assess the result and then quickly make further adjustments in graduated increments until the ideal sized vent was achieved. Once this was done the consumer would be able to remember and/or record the desired vent gauge, so they would be able to have this result reproduced the next time without having to go through the trial and error process they used to determine the ideal vent size.

### OBJECTS AND ADVANTAGES

Accordingly, several objects and advantages of my invention of a beverage utensil to create and enlarge vents/holes in disposable cup lids are:

(a) to provide a beverage utensil capable of quickly creating or enlarging a vent on a disposable cup lid.
(b) the vent produced by the utensil allows the cup's liquid to be more easily enjoyed, because there is no need to take periodic drinking breaks to prevent a fluid stopping vacuum from forming as can happen when the vent is too small and not enough surrounding air enters the cup's interior to replace the consumed beverage.
(c) the vent produced by the utensil allows the cup's liquid to be more easily enjoyed, because the vent is large enough to prevent a vacuum from forming that can create a slurping-sound when the vacuum is replaced by surrounding air entering the cup's interior.
(d) the desired vent size created by the utensil can be recorded, remembered, and/or communicated so that that vent size can be reproduced without a lengthy trial and error process.
(e) after creating the desired sized vent, the utensil can be used to plug orifices that can create heat loss and/or spills.
(f) by allowing the user to adjust the size of a beverage cup lid's vent after manufacturing but prior to beverage consumption, lid manufactures are able to make smaller vents that will make transporting beverages more safe and convenient prior to consumption.

Still further objects and advantages will become apparent from a consideration of the ensuing description and drawings.

### BRIEF DESCRIPTION OF THE DRAWINGS

As to organization and method of practice, together with further objects and advantages thereof, may best be understood by references to the following description, taken in connection with the accompanying drawings, in which:

FIG. 1 is an isometric view of a disposable cup lid with a sip hole and lid manufacturer created vent/hole.

FIG. 2 is an isometric view of the beverage utensil comprising of a handle between the two ends of the utensil, one of the ends being tapered and marked with a “?” text symbol, a “!” text symbol, and a “*” text symbol to identify the different portions of the tapered end which also have different diameters which will produce different sized vents in a disposable lid.

FIG. 3 is an isometric view of a disposable cup lid with a vent that was created by the device operator using the invention and a sip hole.

FIG. 4 is an isometric view of a second embodiment of the beverage utensil comprising of a handle between the invention's two ends, one of the ends being tapered and marked with a “&” text symbol to differentiate that portion from other portions.

FIG. 5 is an isometric view of the embodiment of the beverage utensil comprising of a handle between the invention's two ends, one of the ends being tapered and marked with a “#” text symbol to represent that this end has a different diameter than the tapered end shown in FIG. 4.

FIG. 6 is an isometric view of another embodiment of the beverage utensil comprising of a handle between a tapered end marked with a label “&” and a second tapered end which is marked with a “@” text symbol which has a different diameter than the end marked with the “&” text symbol.

FIG. 7 is an isometric view of a combination of the embodiment shown in FIG. 4 and a plug with a handle.

### SUMMARY OF THE INVENTION

Briefly stated, the invention comprises of one or more handles connected to one or more ends with one or more markings to communicate the diameter of the end or portions of the end. Each end can be used to pierce a disposable beverage cup lid by passing the end through the lid until the desired diameter has been reached. The holes that are created are used as vents to allow the beverage flow rate to be increased. The increased flow rate allows the beverage to be drunk more quickly, because the beverage is more quickly replaced with surrounding air. This prevents a vacuum from forming within the cup that would slow or stop the beverage flow. When surrounding air is able to replace the consumed liquid at an adequate rate, a slurping sound is also prevented. Because the end's diameter or portions of the end's diameter are marked the utensil can be quickly identified and chosen to make another same sized vent when desired.

### DETAILED DESCRIPTION

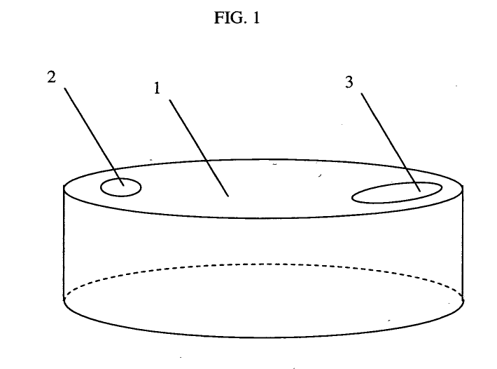

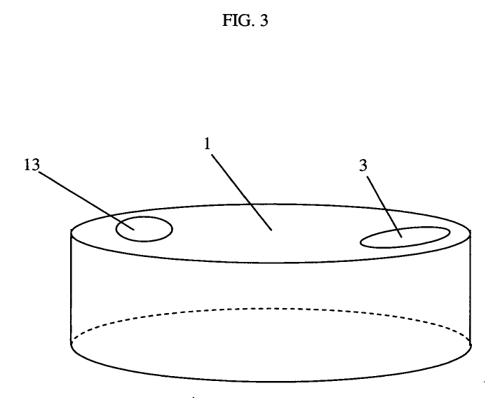

The invention and its embodiments are used to modify disposable beverage cup lids with designs similar to the lids shown in FIG. 1 and FIG. 3. FIG. 1 consists of a disposable beverage lid 1, a lid manufacturer created vent 2, and a sip hole 3. FIG. 3 consists of the disposable beverage lid 1, the sip hole 3, and a vent 13 that is formed when the invention punctures lid 1 and produces a wider diameter than vent 2.

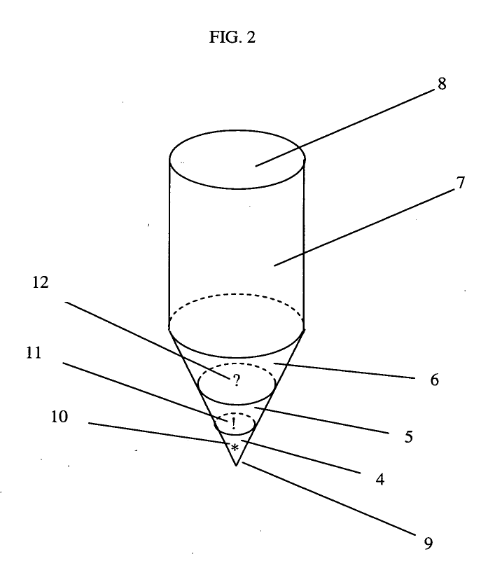

One embodiment of the invention is shown in FIG. 2. This embodiment consists of a handle 7 that is used to hold and guide the direction of the invention, an end 8 which can be used to hold and guide the direction of the invention, and a tapered end 9 so that it can include portion 4, portion 5, and portion 6. Multiple portions are included as part of end 9, because consumers are individuals. Some consumers will want their beverage to flow more quickly than others. By tapering end 9 and allowing different diameter portions known as portion 4, portion 5, and portion 6 the beverage flow rate can quickly be adjusted. The use of portion 5 will make vent 13 have a bigger diameter than will the use of portion 4 when the desired portion passes through the beverage lid 1. The larger hole created by portion 5 will allow the beverage to flow faster than the hole created by portion 4. The use of portion 6 will make vent 13 have a larger diameter than will the use of portion 5 when the desired portion passes through beverage lid 1. The increased diameter of vent 13 after portion 6 has been used will increase the flow rate of beverage lid 1 as compared to a vent 13 which had been modified by portion 5. It should be understood that this embodiment is not limited to three portions.

So that the appropriate portion can be quickly identified in the future, the different portions are marked in some manner. For example, in FIG. 2 portion 4 is marked with a text symbol 10. In FIG. 2 portion 5 is marked with a text symbol 11. In FIG. 2 portion 6 is marked with a text symbol 12.

An alternative to using text symbols to label different portions that have different diameters is to mark the different sized portions with different colors. A manufacturer of this invention could designate each color as having a unique diameter. This would allow portion 4 to have a different color than portion 5, and portion 6 to have a different color than portion 4 or portion 5. When the user selected a color they could be confident that they were selecting a unique diameter and one that if they had previously selected would produce the same diameter vent 13. Because most people learn their colors before they learn to write, using a marking system based on color may be easier for some users with a lower developmental age. It may be difficult to impossible to ask someone to make a vent 13 with the ampersand if someone struggles with language and does not know what an ampersand is. The text symbols that may be used to mark different portions that might be hard for some people to see if the text symbols are written with a small font. Using colors as a marking system would be easier for people with limited vision. It should be understood that text symbols and colors are not the only two possible methods for marking and identifying portions with different diameters so that portion can be easily remembered and communicated for future use.

### MODIFICATIONS

For the embodiments described below it is preferable to taper the piercing end of the invention to allow the beverage lid to be pierced more easily, but it is not necessary to taper the piercing end.

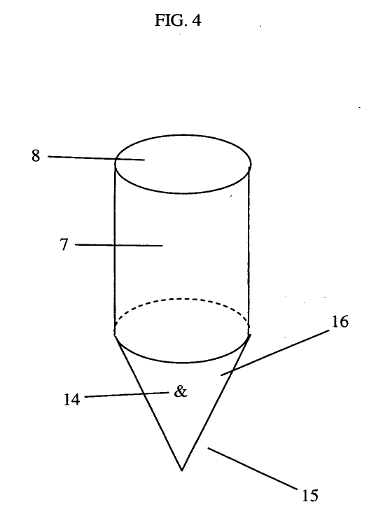

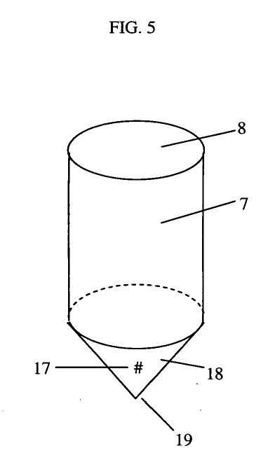

A second embodiment of the invention is shown in FIG. 4 and FIG. 5. This second embodiment consists of modifying end 9 in FIG. 2 to have only one marked portion known as portion 16 and is part of end 15 in FIG. 4 and portion 18 which is part of end 19 in FIG. 5. In FIG. 4 portion 16 is marked with a “&” text symbol 14 to communicate that portion 16 has a different size than the other portions. In FIG. 5 portion 18 is marked with a “#” text symbol 17. As described in the previous embodiment, text symbols are not the only possible method for marking portions with different diameters for identification purposes. Because there is only one marking to be aware when using the utensil in FIG. 4 and FIG. 5, the user may find them easier to use than the embodiment described in FIG. 2.

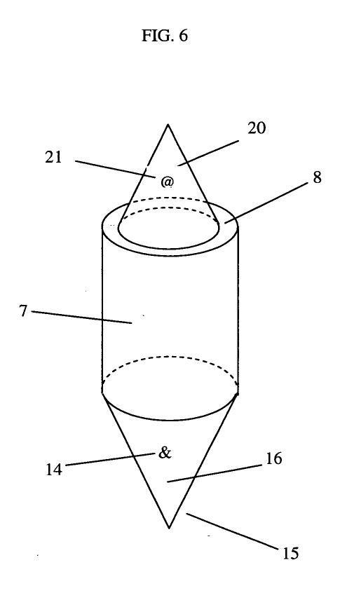

Another embodiment of the invention is shown in FIG. 6. The embodiment includes a handle 7 in between end 8 and end 15. End 8 supports portion 20. Portion 20 has a different size than other portions and that is why it is marked with a “@” text symbol 21. End 15 includes portion 16 as it did in FIG. 4. Portion 16 is still marked with text symbol 14 Both portion 20 and portion 16 can create vent 13 when they pass through vent 2. It should be understood that the number of piercing portions for this embodiment does not need to be limited to two. While using portion 20, the user will know that they have made the appropriate sized vent when end 8 meets lid 1 that they are piercing. The ease of knowing when the desired vent size has been reached may be the most important criteria for the user, so they may prefer to have a utensil that has this feature on both ends but with different sizes. Still others users may just want two different diameters on two different ends so that they only need to watch one portion during operation of the utensil.

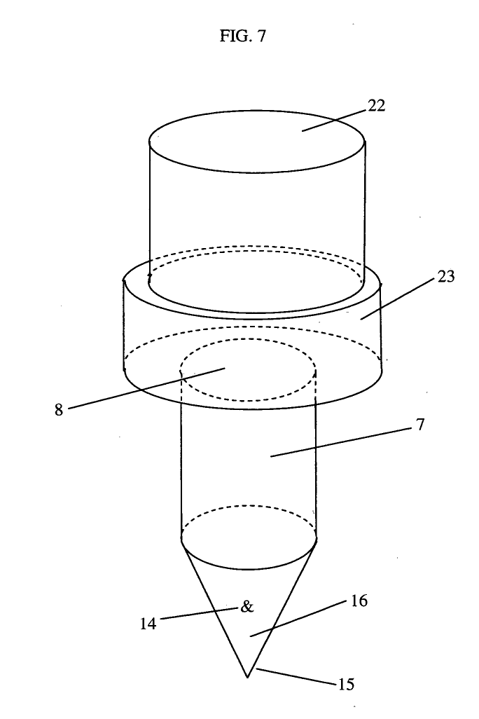

In addition to changing the number, size, and arrangement of piercing portions the embodiment in FIG. 7 describes another possibility. The embodiment in FIG. 7 includes a handle 22 attached to a plug 23 that is connected to end 8 of the embodiment described in FIG. 4. After using text symbol 14, end 15 with portion 16 and handle 7 to achieve the appropriate vent 13 as described earlier, handle 22 can be used to insert end 15 into sip hole 3 until plug 23 frictionally engages the edges of sip hole 3. When plug 23 frictionally engages the sides of sip hole 3 a seal is created to prevent the cup's beverage from leaving the cup. The combination shown in FIG. 7 is not the only possible design to seal sip hole 3 with plug 23. The embodiment described in FIG. 7 may be favorable to coffee house staff, because it would allow the coffee house staff to receive a utensil that enlarges or creates holes in disposable cup lids and a device to prevent spills from the sip hole 3 in one transaction from the manufacturer. The ability to give a utensil that enlarges or creates holes in disposable cup lids and a device to prevent spills from the sip hole 3 in one'transaction to coffee house customers in one transaction may also be favorable to the coffee house staff.

### Operation of the Invention

In operation, a user determines what size diameter they would like vent 13 to have by selecting a portion with that diameter. If they were using the embodiment in FIG. 2 they would select from portion 4, portion 5, or portion 6. The embodiment in FIG. 4 would allow the user to use portion 16. The embodiment in FIG. 5 would allow the user to use portion 18. Portions 16 and 20 could be used if the embodiment in FIG. 6 were chosen. Portion 16 would also be available if using the embodiment described in FIG. 7.

When changing vent 2 using the embodiment in FIG. 2, the user begins by picking up the invention by handle 7 and possibly by end 8. End 9 is place placed on vent 2. The user then pushes handle 7 and possibly end 8 toward vent 2 stopping just after the marking for the desired portion is no longer visible. The invention can then be removed from the lid so that beverage consumption can begin. If the user is confident that vent 13 is the right size they could also leave the utensil in vent 13 to prevent heat loss or possible spilled beverage through vent 13.

If the user determines that the size of vent 13 needs to be increased they could simply remove the utensil and try a bigger sized portion until the desired vent 13 size was achieved. The invention can then be removed from the lid so that beverage consumption can begin or left in vent 13 to prevent heat loss or possible spilled beverage through vent 13.

Once vent 13 has the desired diameter, the user can note the portion's markings for future reference and to be able to tell someone else what size vent 13 they prefer and what portion to use to achieve that sized vent.

When changing vent 2 using the embodiment in FIG. 4 or FIG. 5, the user begins by picking up the invention by handle 7 and possibly by end 8. End 15 is placed on vent 2 when using the embodiment in FIG. 4. End 19 is placed on vent 2 when using the embodiment in FIG. 5. The user then pushes handle 7 and possibly end 8 toward vent 2 stopping just after the marking for the desired portion is no longer visible. For the embodiment in FIG. 4 this would mean stopping just after portion 16 no longer visible. When using the embodiment shown in FIG. 5 stopping would occur just after portion 18 is no longer in view. The invention can then be removed from the lid so that beverage consumption can begin. If the user is confident that vent 13 is the right size they could also leave the utensil in vent 13 to prevent heat loss or possible spilled beverage through vent 13.

If the user determines that the size of vent 13 needs to be increased they could simply remove the utensil and try a bigger sized portion until the desired vent 13 size was achieved. The invention can once again then be removed from the lid so that beverage consumption can begin or left in vent 13 to prevent heat loss or possible spilled beverage through vent 13.

Once vent 13 has the desired diameter, the user can note the portion's markings for future reference and to be able to tell someone else what size vent 13 they prefer and what portion to use to achieve that sized vent.

When changing vent 2 using end 15 of the embodiment in FIG. 6, the operation of end 15, handle 7, end 8, portion 16, and text symbol 14 are the same as they are described for use of the embodiment in FIG. 4. If end 20 is used, the user begins by picking up the invention by handle 7 and possibly by end 15. End 20 is placed on vent 2. The user then pushes handle 7 and possibly end 15 toward vent 2 stopping when end 8 and lid 1 meet. The invention can then be removed from the lid so that beverage consumption can begin. If the user is confident that vent 13 is the right size they could also leave the utensil in vent 13 to prevent heat loss or possible spilled beverage through vent 13.

If the user determines that the size of vent 13 needs to be increased they could simply remove the utensil and try a bigger sized portion until the desired vent 13 size was achieved. The invention can once again then be removed from the lid so that beverage consumption can begin or left in vent 13 to prevent heat loss or possible spilled beverage through vent 13.

Once vent 13 has the desired diameter, the user can note the portion's markings for future reference and to be able to tell someone else what size vent 13 they prefer and what portion to use to achieve that sized vent.

Prior to using the embodiment in FIG. 7 to enlarge vent 2, the user could use plug 23 to prevent an accidental spill of the beverage from sip hole 3. The user would achieve this goal by holding handle 22 and inserting end 15 in sip hole 3 until plug 23 was frictionally engaged with the sides of sip hole 3. The frictional engagement of plug 22 with sip hole 3 would create surface tension to prevent the beverage from leaving sip hole 3. It should be understood that the insertion of plug 23 to prevent accidental spills from sip hole 3 can also be done at any other time there is a risk of spilling liquid through sip hole 3.

When changing vent 2 using end 15 of the embodiment in FIG. 7, the user begins by picking up the invention with handle 7 and/or handle 22. End 15 is placed on vent 2. The user then pushes handle 7 and/or handle 22 toward vent 2 stopping just after portion 16 is no longer visible. The invention can then be removed from the lid so that beverage consumption can begin. If the user is confident that vent 13 is the right size they could also leave the utensil in vent 13 to prevent heat loss or possible spilled beverage through vent 13.

If the user determines that the size of vent 13 needs to be increased they could simply remove the utensil and try a bigger sized portion until the desired vent 13 size was achieved. The invention can once again then be removed from the lid so that beverage consumption can begin or left in vent 13 to prevent heat loss or possible spilled beverage through vent 13.

Once vent 13 has the desired diameter, the user can note the portion's markings for future reference and to be able to tell someone else what size vent 13 they prefer and what portion to use to achieve that sized vent.

While the previous descriptions of the embodiments of the beverage utensil to create and enlarge vents/holes in lid 1 have explained how to enlarge vent 2 to become vent 13, it should be understood that vent 13 could be formed without using vent 2. To create vent 13 without using vent 2, the user would substitute an area on lid 1 for vent 2 and proceed as if they were working with vent 2.

### CONCLUSION, RAMIFICATIONS, AND SCOPE

Thus the reader will see that the beverage utensil of the invention provides a number of advantages over prior art in that
it permits easy addition or enlargement of vents in disposable beverage lids;
it allows the beverage consumer to tailor the beverage flow rate to their preferences;
it allows for markings that will help the user to remember, note, and/communicate the diameter of the utensil used to create the desired vent size;
it allows the beverage to be consumed more quietly;
it can be used to plug orifices that can create heat loss and/or spills;
by allowing the user to adjust the size of a beverage cup lid's vent, lid manufactures are now able to make smaller vents that will make transporting beverages more safe and convenient.

While my previous description contains many specifications these should not be construed as limitations on the scope of the invention, but rather as an exemplification of the embodiments thereof. Many other variations are possible. For example the vent that the beverage lid manufacturer includes can have other shapes that might then necessitate changing the inventions shape. It may be desirable to make the invention small enough that it can be stored in the open space between the two layers that form a cup's sleeve. Thus the scope of the invention should be determined by the appended claims and their legal equivalents, rather than by the examples given.

I claim:

1. A beverage utensil to create and enlarge vents/holes in disposable cup lids that allows the user to increase a beverage's flow rate out of a disposable cup and allows a beverage within the cup to be consumed more quickly and quietly, said device comprising of a tapered end with individual identifying features for each of the tapered end's portions, so as to inform the user and others about a vent's diameter the portion with the identifying feature is capable of producing when the portion is inserted into the disposable lid, said tapered portion is connected to a handle for grasping in the hand of the user which allows the user to guide the direction of the tapered end during the creation or enlarging of said vent in said lid.

2. The identifying feature in claim 1 wherein said identifying feature is a color.

3. The identifying feature in claim 1 wherein said identifying feature is a text character.

4. The identifying feature in claim 1 wherein said identifying feature is a geometric shape.

5. The handle in claim 1 wherein said handle is also connected to a plug which is inserted into a disposable cup lid's sip hole and prevents a beverage from leaving a disposable cup by sealing said sip hole.

6. The plug in claim 5 wherein said plug is connected to a second handle which may also be used to guide the position and motion of the utensil in claim 1.

7. A beverage utensil to create and enlarge vents/holes in a disposable cup lid that allows a user to increase a beverage's flow rate out of a disposable cup and allows a beverage within the cup to be consumed more quickly and quietly, the device comprising of an end with a portion which can be identified by a change in the utensil's diameter and one or more identifying features or one or more identifying features other than a change in the utensil's diameter, said identifying feature or features inform the user and others about a vent's diameter the portion with said identifying feature is capable of producing when said portion is inserted into said disposable lid, said portion is connected to a handle for grasping in the hand of said user which allows said user to guide the direction of said portion during the creation or enlarging of said vent in said lid.

8. The identifying feature in claim 7 wherein said identifying feature is a color.

9. The identifying feature in claim 7 wherein said identifying feature is a text character.

10. The identifying feature in claim 7 wherein said identifying feature is a geometric shape.

11. The utensil's change in diameter in claim 7 wherein said utensil's change in diameter is capable of alerting the user that the maximum diameter of the portion in claim 7 has been reached.

12. The handle in claim 7 wherein said handle is also connected to a plug which is inserted into a disposable cup lid's sip hole and prevents a beverage from leaving a disposable cup by sealing said sip hole.

13. The plug in claim 12 wherein said plug is connected to a second handle which may also be used to guide the position and motion of the utensil in claim 7.

14. The handle in claim 7 wherein said handle is also connected to a second portion with a different diameter than the portion in claim 7, said second portion can be identified by a change in the utensil's diameter and one or more identifying features or one or more identifying features other than a change in the utensil's diameter, said identifying feature or features inform the user and others about a vent's diameter the portion with said identifying feature is capable of producing when said portion is inserted into said disposable lid, said portion is connected to a handle for grasping in the hand of said user which allows said user to guide the direction of said portion during the creation or enlarging of said vent in said lid.

15. The identifying feature in claim 14 wherein said identifying feature is a color.

16. The identifying feature in claim 14 wherein said identifying feature is a text character.

17. The identifying feature in claim 14 wherein said identifying feature is a geometric shape.

18. The utensil's change in diameter in claim 14 wherein said utensil's change in diameter is capable of alerting the user that the maximum diameter of the portion in claim 14 has been reached.
